(19) United States
(12) Patent Application Publication
(10) Pub. No.: US 2026/0203537 A1
(43) Pub. Date: Jul. 16, 2026

(54) DISPLAY MEDIUM INCLUDING INFORMATION CODE, INFORMATION CODE GENERATING DEVICE, AND STORAGE MEDIUM

(71) Applicant: DENSO CORPORATION, Kariya-city (JP)

(72) Inventors: Hiroki ABE, Kariya-city (JP); Tatsuya OKABE, Kariya-city (JP)

(21) Appl. No.: 19/555,325

(22) Filed: Mar. 3, 2026

Related U.S. Application Data
(63) Continuation of application No. PCT/JP2024/029559, filed on Aug. 21, 2024.

(30) Foreign Application Priority Data
Sep. 8, 2023 (JP) 2023-146447

(51) Int. Cl. G06K 7/14; G06K 7/12

(52) U.S. Cl. CPC G06K 7/1434; G06K 7/12

(57) ABSTRACT

An information code records a public code and a hidden code superimposed in a common two-dimensional area by arranging cells in which at least either a first symbol or a second symbol is encoded. The information code displays: cells in which the first symbol is encoded in both the codes in black; cells in which the second symbol is embedded in both the codes in white; cells in which the first symbol is embedded in the public code and the second symbol is embedded in the hidden code in red; and cells in which the second symbol is embedded in the public code and the first symbol is embedded in the hidden code in cyan, so as to be recognized by a reader with higher luminance than the cells displayed in red under white light and with lower luminance than the cells displayed in red under red light.

### CROSS REFERENCE TO RELATED APPLICATION

The present application is a continuation application of International Patent Application No. PCT/JP2024/029559 filed on August 21, 2024, which designated the U.S. and claims the benefit of priority from Japanese Patent Application No. 2023-146447 filed on September 8, 2023. The entire disclosures of all of the above applications are incorporated herein by reference.

### TECHNICAL FIELD

The disclosure of this specification relates to technology for realizing highly convenient information code.

### BACKGROUND

An information code can store a large amount of information by using difference in color wavelengths or ink with magnetic properties.

### SUMMARY

According to one aspect of the disclosure, a display medium includes an information code to be decoded in response to luminance recognized by a reader. The information code records a first code representing first information and a second code representing second information in a superimposed manner in a common two-dimensional area by arranging cells in which at least a first symbol or a second symbol is encoded in each of the first code and the second code. A cell in which the first symbol is coded in the first code and the first symbol is coded in the second code is displayed in a first color that is black through a binarization process. A cell in which the second symbol is coded in the first code and the second symbol is coded in the second code is displayed in a second color that is white through a binarization process. A cell in which the first symbol is coded in the first code and the second symbol is coded in the second code is displayed in a first auxiliary color. A cell in which the second symbol is coded in the first code and the first symbol is coded in the second code may be displayed in a second auxiliary color so as to be recognized by a reader with higher luminance under white light than display in the first auxiliary color, and recognized by a reader with lower luminance under light of the first auxiliary color than display in the first auxiliary color.

### BRIEF DESCRIPTION OF DRAWINGS

FIG. 1 is a diagram showing a public code, a hidden code, and an information code after synthesis.

FIG. 2 is a diagram for explaining a code generating device and a code reader.

FIG. 3 is a flowchart illustrating an example of a code generating process.

FIG. 4 is a diagram showing a synthesis rule.

FIG. 5 is a graph showing an example of luminance distribution without an optical filter.

FIG. 6 is a diagram illustrating recognition of a white cell under a red color filter.

FIG. 7 is a diagram illustrating recognition of a black cell under a red color filter.

FIG. 8 is a diagram illustrating recognition of a red cell under a red color filter.

FIG. 9 is a diagram illustrating recognition of a cyan cell under a red color filter.

FIG. 10 is a diagram illustrating recognition of an information code when a red color filter is applied.

FIG. 11 is a graph showing an example of luminance distribution when a red color filter is applied.

FIG. 12 is a diagram illustrating recognition of a white cell under a green color filter.

FIG. 13 is a diagram illustrating recognition of a black cell under a green color filter.

FIG. 14 is a diagram illustrating recognition of a red cell under a green color filter.

FIG. 15 is a diagram illustrating recognition of a cyan cell under a green color filter.

FIG. 16 is a graph showing an example of luminance distribution when a green color filter is applied.

FIG. 17 is a diagram showing a traceability system together with a distribution management system.

FIG. 18 is a diagram showing a public code, a hidden code, and an information code after synthesis.

FIG. 19 is a diagram showing a public code, a hidden code, and an information code after synthesis.

### DETAILED DESCRIPTION

An information code can store a large amount of information by using difference in color wavelengths or ink with magnetic properties.

While the information code allows for a large amount of information to be stored, it does not take into consideration the possibility of recording multiple types of information in the same area by superimposing them, and there is room for improvement in terms of convenience.

The present disclosure provides an information code, an information code generating device, and an information code generating program that are highly convenient to read.

According to one aspect of the disclosure, an information code is decoded in response to luminance recognized by a reader.

The information code records a first code representing first information and a second code representing second information in a superimposed manner in a common two-dimensional area by arranging cells in which at least a first symbol or a second symbol is encoded in each of the first code and the second code.

A cell in which the first symbol is coded in the first code and the first symbol is coded in the second code is displayed in a first color that is black through a binarization process.

A cell in which the second symbol is coded in the first code and the second symbol is coded in the second code is displayed in a second color that is white through a binarization process.

A cell in which the first symbol is coded in the first code and the second symbol is coded in the second code is displayed in a first auxiliary color.

A cell in which the second symbol is coded in the first code and the first symbol is coded in the second code is displayed in a second auxiliary color so as to be recognized by a reader with higher luminance under white light than display in the first auxiliary color, and recognized by a reader with lower luminance under light of the first auxiliary color than display in the first auxiliary color.

According to another aspect of the disclosure, an information code generating device includes at least one processor to generate an information code that is readable by a reader by performing a binarization process on luminance.

The at least one processor is configured to generate an information code in which a public code representing public information is recorded by arranging a plurality of cells in which either a first symbol or a second symbol that can be distinguished by binarization process is embedded, and a hidden code representing hidden information is recorded by arranging a plurality of cells in which either the first symbol or the second symbol is embedded, in a superimposed manner in a common two-dimensional area.

The at least one processor, in the generating of the information code, is configured to:

set a cell in which the first symbol is embedded in the public code and the first symbol is embedded in the hidden code to be displayed in black;

set a cell in which the second symbol is embedded in the public code and the second symbol is embedded in the hidden code to be displayed in white;

set a cell in which the first symbol is embedded in the public code and the second symbol is embedded in the hidden code to be displayed in a first auxiliary color; and

set a cell in which the second symbol is embedded in the public code and the first symbol is embedded in the hidden code to be displayed in a second auxiliary color so as to be recognized by a reader with higher luminance under white light than display in the first auxiliary color and recognized by a reader with lower luminance under light of the first auxiliary color than display in the first auxiliary color.

According to another aspect of the disclosure, an information code generating program, to generate an information code that is readable by a reader by performing a binarization process on luminance, causes at least one processor to:

generate an information code storing a public code representing public information and a hidden code representing hidden information in superimposed manner in a common two-dimensional area by arranging a plurality of cells in which either a first symbol or a second symbol that can be distinguished by a binarization process is embedded.

In the generating of the information code,

a cell in which the first symbol is embedded in the public code and the first symbol is embedded in the hidden code is set to be displayed in black,

a cell in which the second symbol is embedded in the public code and the second symbol is embedded in the hidden code is set to be displayed in white,

a cell in which the first symbol is embedded in the public code and the second symbol is embedded in the hidden code is set to be displayed in a first auxiliary color, and

a cell in which the second symbol is embedded in the public code and the first symbol is embedded in the hidden code is set to be displayed in a second auxiliary color so as to be recognized by a reader under white light with a higher luminance than display in the first auxiliary color and recognized by a reader under light of the first auxiliary color with a lower luminance than display in the first auxiliary color.

According to these aspects, the second auxiliary color can be recognized by a reader with higher luminance under white light than display in the first auxiliary color. Therefore, when a reader reads the information code under white light without using an optical filter or the like, the luminance threshold value in the binarization process can be set between the first and second auxiliary colors. Furthermore, cells of a first color and cells of a first auxiliary color perceived as black can be defined to record the first symbol, and cells of a second color and cells of a second auxiliary color perceived as white can be defined to record the second symbol. That is, the information code is read substantially as the first code (for example, the public code).

On the other hand, the second auxiliary color can be recognized by a reader at a lower luminance than the display in the first auxiliary color under light of the first auxiliary color. Therefore, under the light of first auxiliary color (including the case where a reader reads an information code through an optical filter that reproduces the light of first auxiliary color), the roles of the first and second auxiliary colors are reversed. In more detail, cells of a first color and cells of a second auxiliary color recognized as black can be defined to record the first symbol, and cells of a second color and cells of a first auxiliary color recognized as white can be defined to record the second symbol. That is, the information code is essentially read as the second code (for example, the hidden code).

Therefore, the information to be read from the first code (for example, a public code) and the second code (for example, a hidden code) recorded in superimposed manner on a common two-dimensional area can be selected simply by the presence or absence of an optical filter, for example, eliminating the need to prepare completely separate readers capable of reading each information. Therefore, the convenience of reading can be dramatically improved.

Hereinafter, embodiments will be described with reference to the drawings. It should be noted that, in the following embodiments, corresponding components are denoted by the same reference numerals, and redundant descriptions may be omitted. In cases where only a part of the configuration is described in each embodiment, the configurations of other portions previously described in other embodiments may be applied to those parts. Furthermore, in the descriptions of each embodiment, not only the explicitly stated combinations of configurations, but also, as long as there is no particular hindrance to their combination, configurations from multiple embodiments may be partially combined with each other, even if such combinations are not explicitly described.

### First Embodiment

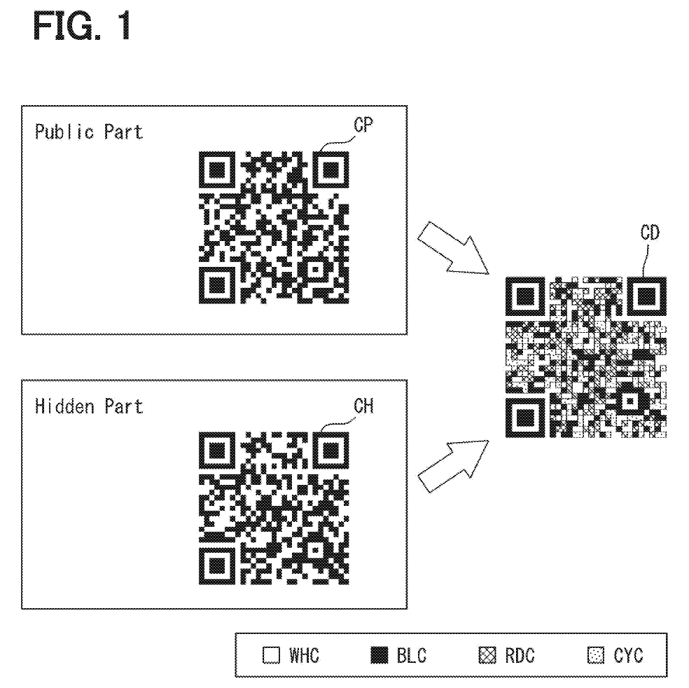

As shown in FIG. 1, an information code CD according to a first embodiment of the present disclosure is generated by a process of combining two two-dimensional codes. The information code CD stores two two-dimensional codes superimposed on a common two-dimensional area. The two-dimensional code that is the basis of the information code CD is, for example, a QR code (registered trademark), and information is recorded by a two-dimensional arrangement of plural cells. The information code CD may be an image displayed on an electronic display device such as display 1d.

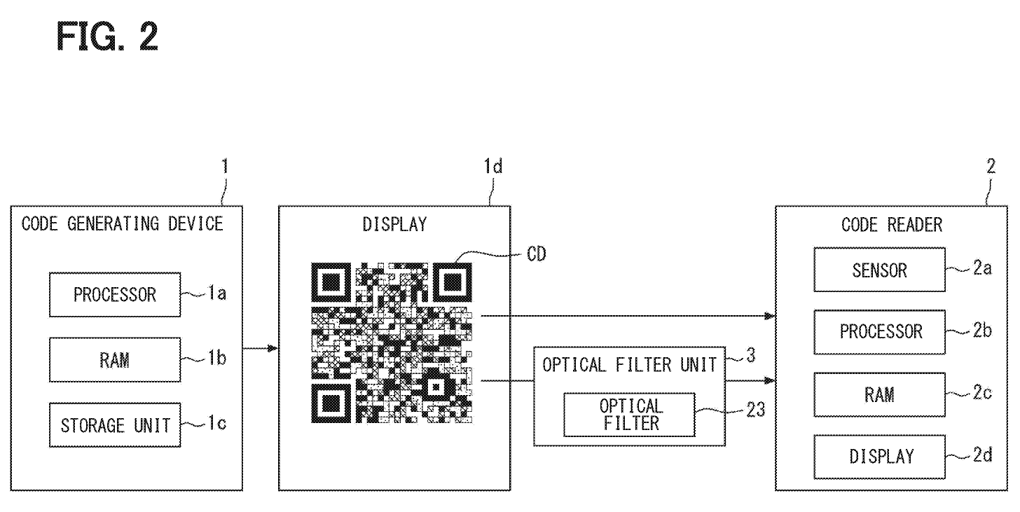

The information code CD is generated by a code generating device 1 shown in FIG. 2 by combining a public code CP and a hidden code CH. When the information code CD is read using a normal code reader 2 and method, the information code CD is recognized as a public code CP. In this case, the information recorded in the public code CP (hereinafter referred to as public information) is read out. On the other hand, the hidden code CH can be read by reading the information code CD with the code reader 2 through a predetermined optical filter 23. In this case, the information recorded in the hidden code CH (hereinafter referred to as hidden information) is read out.

For example, the information code CD may be used by being displayed on product price plates, menus, etc. in retail stores and restaurants. In this case, the public information that the customer can read using a normal reading method without using the optical filter 23 on their own smartphone, etc., should be information that is useful to the customer, such as the address of a web page that contains an explanation of the product's functions, menu details, etc. On the other hand, the hidden information may be useful to retail stores or restaurants, such as information about product managers, inventory information, and ordering information.

The code reader 2 is a reading device that reads either public information or hidden information by reading the information code CD. The code reader 2 may be a general-purpose mobile terminal such as a smartphone or may be a dedicated terminal such as a handheld terminal used in logistics, retail, or manufacturing. In this case, the code reader 2 includes a sensor 2a, a processor 2b, a RAM 2c, and a display 2d. The sensor 2a may be an image sensor having a two-dimensional array of CCD elements that detect light. The image sensor is capable of reading information recorded in a two-dimensional area with high resolution.

The processor 2b includes, for example, at least one type of a central processing unit (CPU), a graphics processing unit (GPU), and a reduced instruction set computer (RISC)-CPU as a core. The processor 2b performs code reading processing to decode the signal read by the image sensor in accordance with a predetermined rule, and obtains the public information or the hidden information recorded on the information code CD. The processor 2b may display the acquired information on the display 2d, may store the acquired information in an internal storage medium, or may transmit the acquired information to an external device.

The code reader 2 decodes the information code CD in response to the luminance. The code reader 2 performs binarization process on the two-dimensional area detected by the sensor 2a based on a luminance threshold LT, and reads the information code CD. That is, an area in which a luminance higher than the luminance threshold LT is detected can be recognized as being substantially white. An area having a detected luminance below the luminance threshold LT can be perceived as being substantially black. The luminance threshold TL may be, for example, the average luminance of the two-dimensional area in which the information code CD is displayed.

Furthermore, the code reader 2 may include an optical filter unit 3 for switching the information to be read between the public code CP and the hidden code CH. The optical filter unit 3 may be attached to the exterior of the sensor 3a and may be configured to switch between an exposed state and a filter state using a switch, lever, or the like. In the exposed state, the sensor 3a is optically exposed to the outside (i.e., a state in which the optical filter 23 is not interposed). In the filter state, the sensor 3a detects light via the optical filter 23. On the other hand, the code reader 2 does not necessarily have to include the optical filter unit 3. The optical filter 23 may be provided separately from the code reader 2.

The code generating device 1 is configured to generate the information code CD. The code generating device 1 may be, for example, a general-purpose mobile terminal such as a smartphone, a personal computer, or a business computer used in logistics, retail, or manufacturing. The code generating device 1 is mainly composed of a computer including a processor 1a, a RAM 1b, a storage unit 1c, an input/output interface, and a bus connecting these components. The processor 1a is hardware for arithmetic processing that is coupled to the RAM 1b. The processor 1a includes, for example, at least one type of a central processing unit (CPU), a graphics processing unit (GPU), and a reduced instruction set computer (RISC)-CPU as a core. The processor 1a accesses the RAM 1b to execute various processes related to the information code CD. The storage unit 1c stores an information code generating program for causing the processor 1a to execute the information code generating method according to the present disclosure.

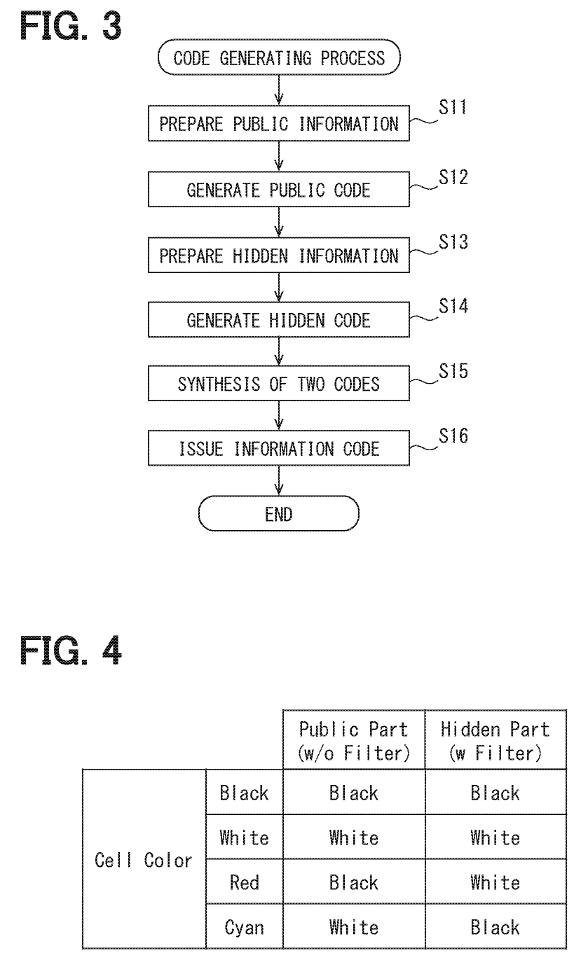

The information code CD and the method for generating the information code CD will be described in detail. The flowchart in FIG. 3 shows an example of a method for generating the information code CD. The code generating process shown in S11 to S16 in FIG. 3 is realized by the processor 1a of the code generating device 1 executing an information code generating program.

In S11, the code generating device 1 prepares public information. The public information may be input or selected by a user operating the code generating device 1. The public information may be acquired from an external device communicably connected to the code generating device 1. After the process in S11, the process proceeds to S12.

In S12, the code generating device 1 generates the public code CP based on the public information. The public code CP is a QR code expressed by a two-dimensional array of cells of two colors, for example, white cells WHC and black cells BLC. In a two-dimensional array of two-color cells, it may be assumed that the white cells WHC are converted to 0 and the black cells BLC are converted to 1. In other words, 0 coded in the form of a cell may be the white cell WHC, and 1 coded in the form of a cell may be the black cell BLC. After the process in S12, the process proceeds to S13.

In S13, the code generating device 1 prepares hidden information. The hidden information may be input or selected by a user operating the code generating device 1. The hidden information may be acquired from an external device communicably connected to the code generating device 1. After the process in S13, the process proceeds to S14.

In S14, the code generating device 1 generates the hidden code CH based on the hidden information. The hidden code CH is a QR code expressed by a two-dimensional array of cells of two colors, such as white cells WHC and black cells BLC. The version of the hidden code CH is preferably the same as the public code CP, but may be different. The version indicates the size of the code, and the larger the version value, the larger the code size. After the process in S14, the process proceeds to S15.

In S15, the code generating device 1 combines the public code CP and the hidden code CH. That is, the public code CP and the hidden code CH are stored superimposed on each other in a common two-dimensional area as an information code CD. After the process in S15, the process proceeds to S16.

In S16, the code generating device 1 issues the information code CD. The term "issue" may mean displaying the information code CD on the display 1d provided in the code generating device 1. Furthermore, the issuing may mean transmitting the information code CD to the external display 1d on which the information code CD is to be displayed or to a computer that controls the display 1d. The series of steps is finished after S16.

The synthesis step in S15 and the reading of the information code CD will be described in more detail. The color of each cell of the information code CD is determined automatically according to a preset synthesis rule. The synthesis rule is, for example, shown in FIG. 4.

According to the synthesis rule of FIG. 4, when the public code CP is a black cell BLC and the hidden code CH is a black cell BLC in the overlap cells, the information code CD after synthesis is a black cell BLC. In the overlap cells, when the public code CP is a white cell WHC and the hidden code CH is a white cell WHC, the information code CD after synthesis is a white cell WHC. In the overlap cells, when the public code CP is a black cell BLC and the hidden code CH is a white cell WHC, the information code CD after synthesis becomes a red cell RDC. In the overlap cells, when the public code CP is a white cell WHC and the hidden code CH is a black cell BLC, the information code CD after synthesis becomes a cyan cell CYC.

This synthesis rule is set on the assumption that the optical filter 23 used in reading is the red color filter 23a. The red color filter 23a is a wavelength-selective long-pass filter configured to transmit almost all red light of 620 to 750 nm and block green and blue lights having shorter wavelengths. The red color filter 23a may be a band-pass filter that transmits only red light of 620 to 750 nm.

The additional colors added in the synthesis rule, namely red and cyan, are selected so that when the code reader 2 performs the above-mentioned binarization process as a normal reading method, the judgment results are reversed depending on whether or not the red color filter 23a is present.

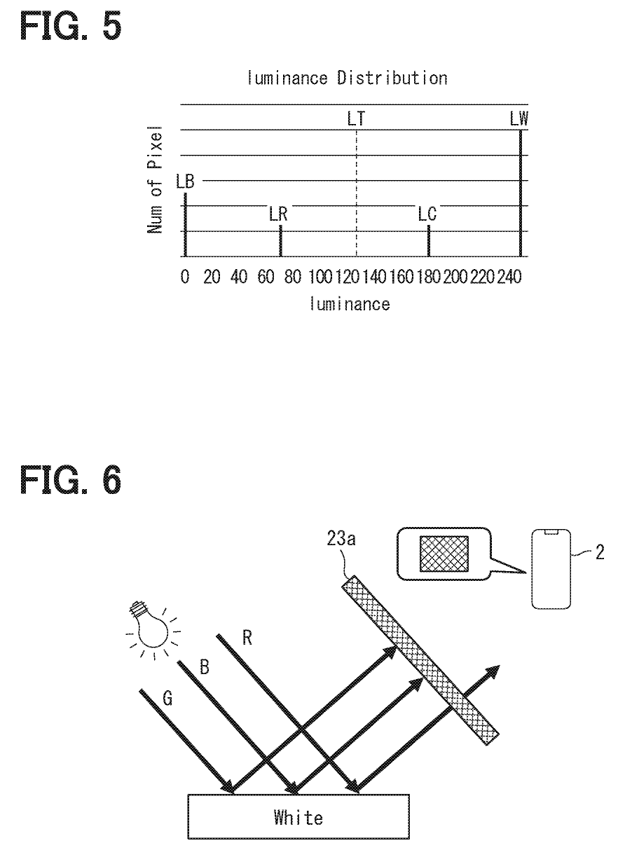

FIG. 5 shows the luminance distribution and luminance threshold LT of the information code CD for each cell when, for example, the red color filter 23a is not used, that is, when the information code CD is read under white light. The luminance under white light can be perceived as increasing in the order of black cell BLC, red cell RDC, cyan cell CYC, and white cell WHC. That is, the luminance under white light can be perceived as gradually increasing in the order of luminance LB corresponding to black, luminance LR corresponding to red, luminance LC corresponding to cyan, and luminance LW corresponding to white. Furthermore, the luminance difference between the red cell RDC and the cyan cell CYC is greater than the luminance difference between the black cell BLC and the red cell RDC and the luminance difference between the cyan cell CYC and the white cell WHC. The combination of additional colors (also called auxiliary colors) is set so that such a relationship is established.

In this case, the luminance threshold TL based on the average luminance of the two-dimensional area is determined between the luminance LR corresponding to red and the luminance LC corresponding to cyan. That is, when reading without the red color filter 23a, the red cells RDC are recognized as black cells BLC, and the cyan cells CYC are recognized as white cells WHC. According to the synthesis rule in FIG. 3, the black cell BLC and the red cell RDC of the information code CD correspond to the black cell BLC of the public code CP. The white cell WHC and the cyan cell CYC of the information code CD correspond to the white cell WHC of the public code CP. Therefore, when the code reader 2 reads the information code CD in the sensor exposed state without the red color filter 23a, it can obtain substantially the same results as reading the public code CP, which has a two-color configuration of a white cell WHC and a black cell BLC.

Next, reading in the filter state will be described with reference to FIGS. 6 to 11. FIGS. 6 to 9 explain what color the cell will be recognized as by the code reader 2 when white light is reflected by the four color cells and then transmitted through the red color filter 23a. The white light in this embodiment is also called natural light, and may be, for example, sunlight.

When the information code CD is displayed on the transmissive liquid crystal display 1d, it is sufficient to assume that white light is transmitted through the liquid crystal panel instead of being reflected, and the perceived color of the cell can be understood using essentially the same principle. Furthermore, the recognition mode through the red color filter 23a can be said to be substantially the same as the mode of reading the information code CD printed on the print medium under red light.

For example, in the white cell WHC shown in FIG. 6, red light, green light, and blue light are reflected. Of the reflected red, green, and blue lights, only the red light passes through the red color filter 23a. Therefore, the white cell WHC can be recognized by the code reader 2 as red or a luminance LR corresponding to red.

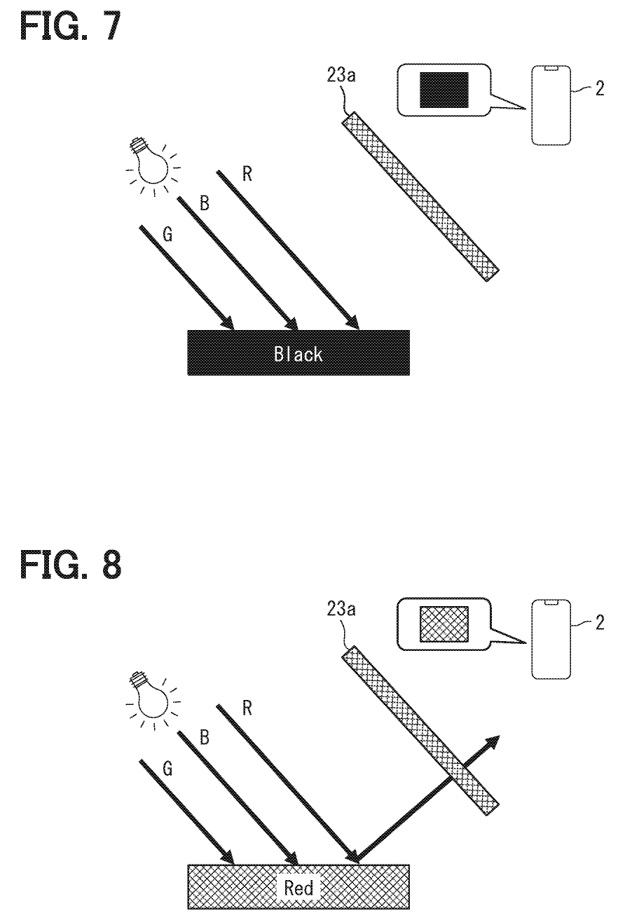

In the black cell BLC shown in FIG. 7, red light, green light and blue light are all absorbed. Therefore, the black cell BLC can be recognized by the code reader 2 as black or a luminance LB corresponding to black.

In the red cell RDC shown in FIG. 8, only the red light is reflected among the red light, green light, and blue light. Then, the red light passes through the red color filter 23a. Therefore, the red cell RDC can be recognized by the code reader 2 as red or a luminance LR corresponding to red.

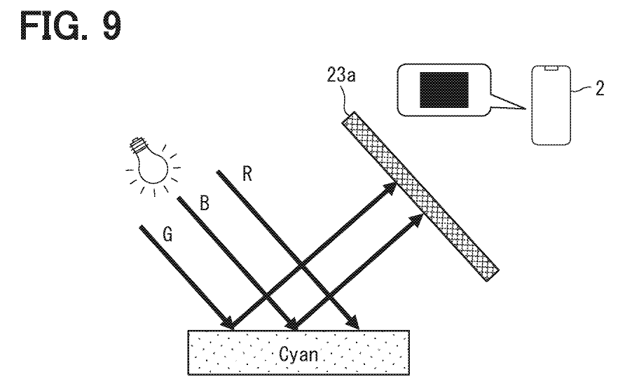

In the cyan cell CYC shown in FIG. 9, the green light and the blue light are reflected, out of the red light, the green light and the blue light. The reflected green and blue lights are then absorbed by the red color filter 23a. Therefore, the cyan cell CYC can be recognized by the code reader 2 as black or a luminance LB corresponding to black.

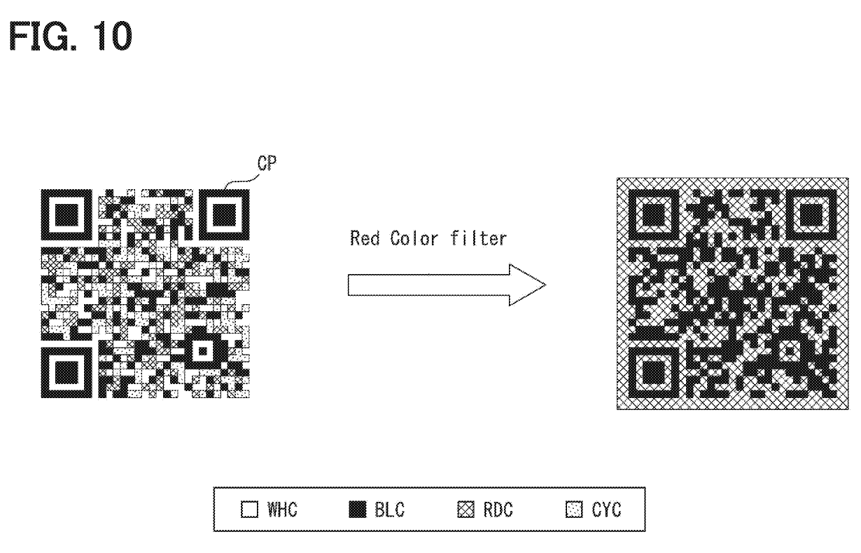

Therefore, as shown in FIG. 10, the information code CD having four color cells including white, black, and two auxiliary colors can be recognized as being composed of two color cells, black cells BLC and red cells RDC, when the red color filter 23a is used. More specifically, the black cell BLC and the cyan cell CYC can be recognized as black or a luminance LB corresponding to black, and the white cell WHC and the red cell RDC can be recognized as red or a luminance LR corresponding to red.

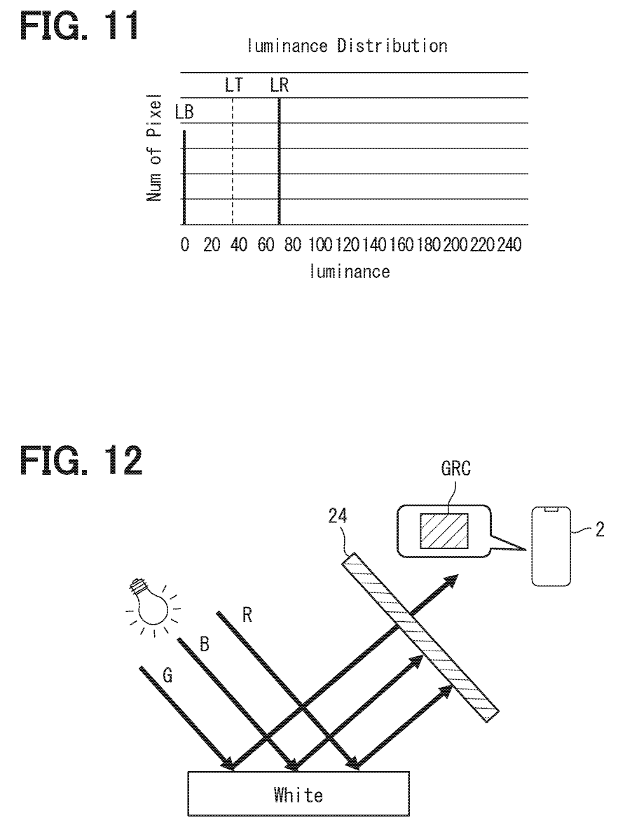

FIG. 11 shows the luminance distribution of the information code CD and the luminance threshold LT for each cell when, for example, the red color filter 23a is present. The luminance distribution is divided into two values: luminance LB corresponding to black and luminance LR corresponding to red. Therefore, the luminance threshold LT in the binarization process is set between the luminance value LB corresponding to black and the luminance value LR corresponding to red.

As a result, in reading with the red color filter 23a, the black cell BLC and the cyan cell CYC can be recognized as the black cell BLC, and the white cell WHC and the red cell RDC can be recognized as the white cell WHC. According to the synthesis rule in FIG. 4, the black cell BLC and the cyan cell CYC of the information code CD correspond to the black cells BLC of the hidden code CH. The white cell WHC and the red cell RDC of the information code CD correspond to the white cells WHC of the hidden code CH. Therefore, when the code reader 2 reads the information code CD with the red color filter 23a applied, it can obtain substantially the same results as reading the hidden code PH, which is composed of two colors: white cells WHC and black cells BLC.

Next, a case will be described with reference to FIGS. 12 to 16, where the information code CD is read using a green color filter 24, instead of the red color filter 23a. FIGS. 12 to 15 explain how the code reader 2 recognizes the color of the cells when white light is reflected by the four color cells and then transmitted through the green color filter 24.

In the white cell WHC shown in FIG. 12, the red light, green light, and blue light are reflected. Of the reflected red, green, and blue lights, only the green light passes through the green color filter 24. Therefore, the white cell WHC can be recognized by the code reader 2 as green or a luminance LG corresponding to green.

In the black cell BLC shown in FIG. 13, red light, green light and blue light are all absorbed. Therefore, the black cell BLC can be recognized by the code reader 2 as black or a luminance LB corresponding to black.

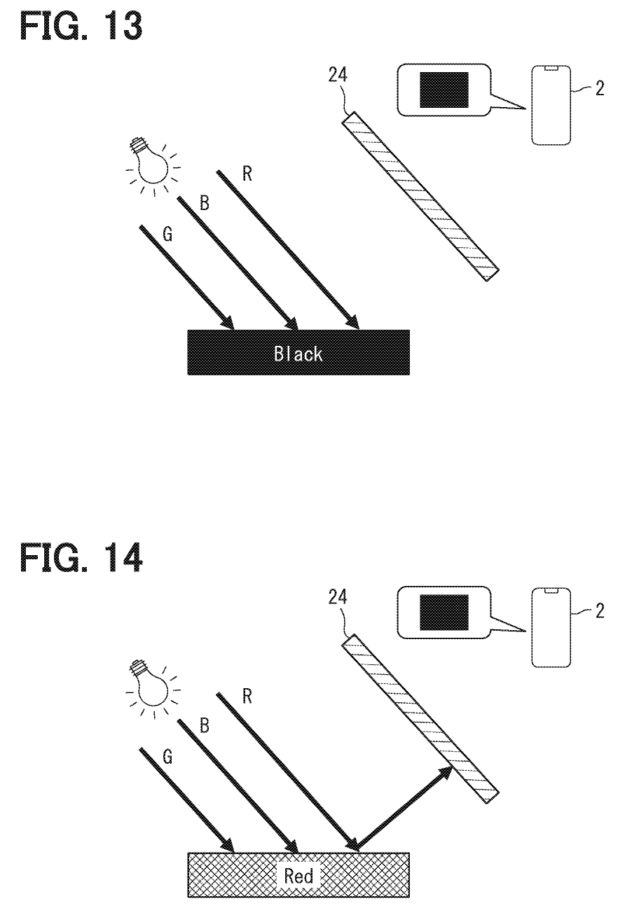

In the red cell RDC shown in FIG. 14, only the red light is reflected among the red light, green light, and blue light. The red light is then absorbed by the green color filter 24. Therefore, the red cell RDC can be recognized by the code reader 2 as black or as a luminance LB corresponding to black.

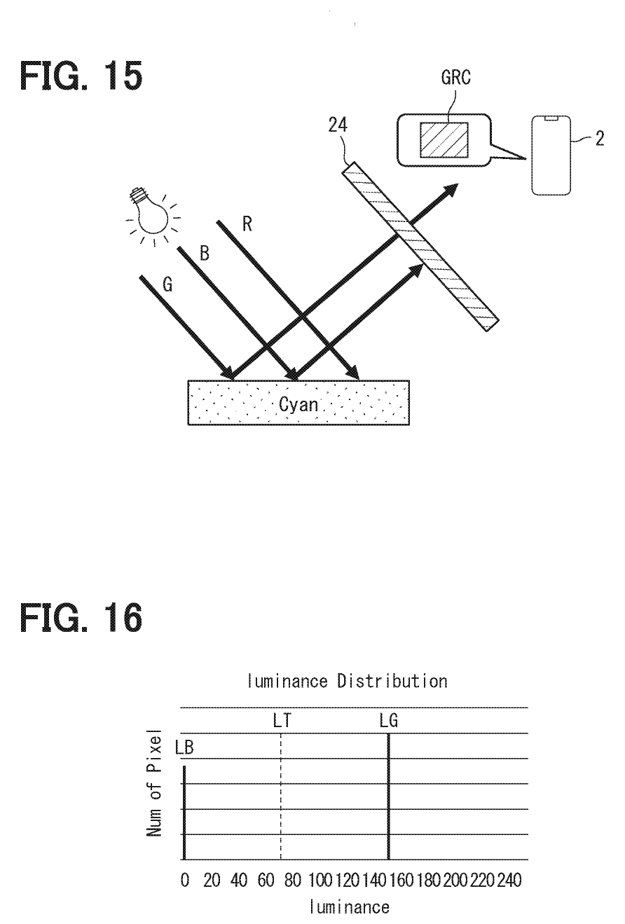

In the cyan cell CYC shown in FIG. 15, the green light and the blue light are reflected out of the red light, the green light and the blue light. Of the reflected green and blue light, the green light passes through the green color filter 24 and the blue light is absorbed by the green color filter 24. Therefore, the cyan cell CYC can be recognized by the code reader 2 as green or a luminance LG corresponding to green.

Therefore, when the green color filter 24 is used, the information code CD having four color cells can be recognized as being composed of two color cells, black cells BLC and green cells GRC. More specifically, the black cell BLC and the red cell RDC can be recognized as black or a luminance LB corresponding to black, and the white cell WHC and the cyan cell CYC can be recognized as green or a luminance LG corresponding to green.

FIG. 16 shows the luminance distribution of the information code CD and the luminance threshold LT for each cell when, for example, the green color filter 24 is present. The luminance distribution is divided into two values: luminance LB corresponding to black and luminance GL corresponding to green. Therefore, the luminance threshold LT in the binarization process is set between the luminance LB corresponding to black and the luminance LG corresponding to green.

As a result, when reading with the green color filter 24, the black cell BLC and the red cell RDC are recognized as the black cell BLC, and the white cell WHC and the cyan cell CYC are recognized as the white cell WHC. Therefore, when the code reader 2 reads the information code CD through the green color filter 24, it can obtain substantially the same results as reading the public code CP, which has a two-color configuration of white cells WHC and black cells BLC.

As is clear from a comparison between FIG. 5 and FIG. 16, when reading with the green color filter 24, the luminance threshold TL and the actually detected luminance become values that are farther apart than when reading in the exposed state without the optical filter 23. Therefore, when it is desired to read the public code CP, using the green color filter 24 can reduce the erroneous recognition of the cells compared to the exposed state.

In the first embodiment, the code generating device 1 corresponds to an information code generating device. The code reader 2 corresponds to a reader. The public code CP corresponds to a first code, and the hidden code CH corresponds to a second code. The public information corresponds to first information, and the hidden information corresponds to second information. "0" corresponds to a first symbol, and "1" corresponds to a second symbol. The red corresponds to a first auxiliary color, and cyan corresponds to a second auxiliary color.

According to the first embodiment, the second auxiliary color can be recognized by the code reader 2 with higher luminance under white light than the first auxiliary color. Therefore, when the code reader 2 reads the information code CD under white light without using, for example, the optical filter 23, the luminance threshold TL in the binarization process can be set between the first auxiliary color and the second auxiliary color. Furthermore, the black cells BLC and the cells RDC of the first auxiliary color can be recognized as recording a first symbol, and the white cells WHC and the cells CYC of the second auxiliary color can be recognized as recording a second symbol. That is, the information code CD is read substantially as the public code CP.

The second auxiliary color can be recognized by the code reader 2 under light of the first auxiliary color with a lower luminance than the display in the first auxiliary color. Therefore, under light of the first auxiliary color (including a case where the code reader 2 reads the information code CD through the optical filter 23 that reproduces the light of first auxiliary color), the roles of the first auxiliary color and the second auxiliary color are reversed. In more detail, the black cell BLC and the cell of the second auxiliary color CYC can be recognized as recording a first symbol, and the white cell WHC and the cell of the first auxiliary color RDC can be recognized as recording a second symbol. That is, the information code CD is essentially read as the hidden code CH.

Therefore, the information to be read from the public code CP and the hidden code CH, which are superimposed and recorded in a common two-dimensional area, can be selected simply by the presence or absence of the optical filter 23, for example, without needing to prepare completely separate code readers 2 for reading each of them. Therefore, the convenience of reading can be dramatically improved.

According to the first embodiment, the first auxiliary color is one of the three primary colors of light. The second auxiliary color is a color obtained by additively mixing the remaining two primary colors of the three primary colors of light. By using such a color combination, it is possible to set a large difference in luminance between the first and second auxiliary colors under white light. At the same time, by making the hue of the first auxiliary color and the hue of the second auxiliary color significantly different, the effect of reversing the perceived luminance under white light and the first auxiliary color is enhanced. As a result, even if the four color cells WHC, BLC, RDC, and CYC are used, it is possible to suppress erroneous recognition when the code reader 2 reads the information code CD.

Furthermore, according to the first embodiment, the first auxiliary color is red, and the second auxiliary color is cyan. This combination can maximize the luminance difference between the first and second auxiliary colors under white light, among combinations using the three primary colors of light. Therefore, the effect of suppressing erroneous recognition can be further improved.

Furthermore, according to the first embodiment, the information code CD is an image display object displayed on an electronic display device (for example, the display 1d). In the information code CD displayed on the electronic display device, it is relatively easy to express the luminance difference between the first and second auxiliary colors.

### Second Embodiment

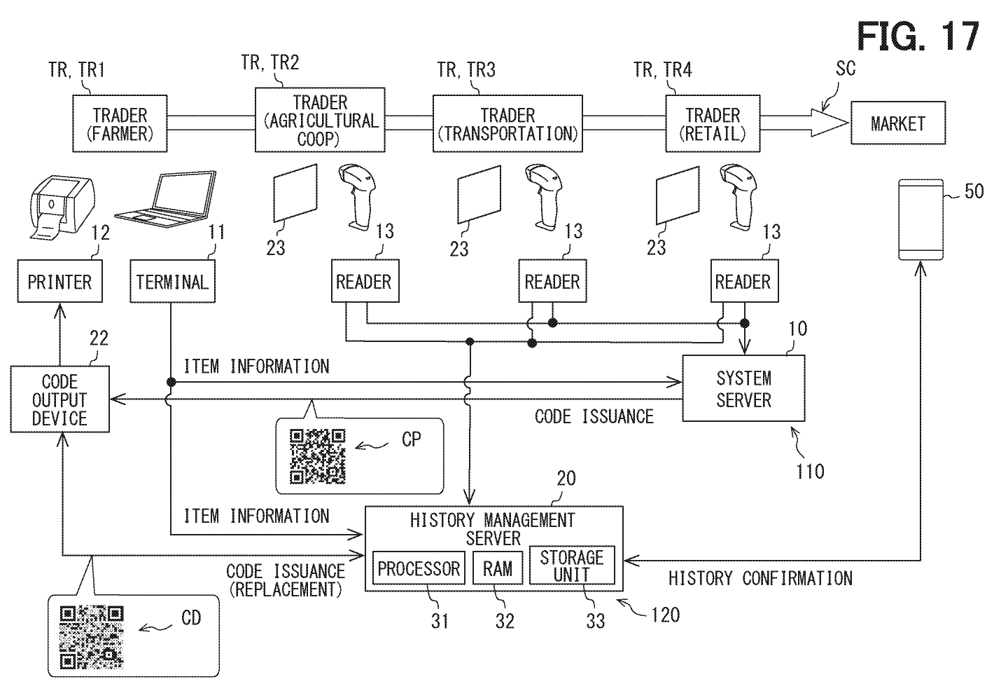

As shown in FIG. 17, a second embodiment is a modification of the first embodiment. The second embodiment will be described mainly with respect to points that differ from the first embodiment.

The information code CD is used in both the distribution management system 110 and the traceability system 120. The distribution management system 110 and the traceability system 120 are management systems that manage a supply chain SC structured to include a large number of traders TR. The supply chain SC is a connection between the traders TR for delivering, for example, industrial products, agricultural products, and marine products to consumers. As an example, in the supply chain SC shown in FIG. 12 for delivering agricultural products to consumers, the traders TR include a farmer TR1, an agricultural cooperative TR2 which is a collection facility, a transporter TR3, and a retailer TR4.

The distribution management system 110 collects records of item transactions between the traders TR using item codes, which are examples of the public code CP. In other words, the item code is managed by the distribution management system 110. The distribution management system 110 is composed of an input terminal 11, a label printer 12, a code reader 13, a system server 10, and the like. The label printer 12 and the code reader 13 are appropriately installed at the premises of each trader TR. The input terminal 11, the label printer 12, and the code reader 13 are communicably connected to the system server 10 installed in a data center or the like via a network.

For example, the input terminal 11 is a personal computer or a tablet terminal. Basic information on the item (hereinafter referred to as item information) provided to the supply chain SC is input to the input terminal 11 according to a predetermined format. For example, the item information includes an article name, a production place, a production facility, and a producer. The input terminal 11 transmits item information of the items to be shipped from the trader TR to the system server 10.

The label printer 12 is an output device for printing the information code CD including an item code on a paper medium. The label printer 12 is capable of printing in color and grayscale. The paper medium on which the information code CD is printed is attached to the package or outer box of the trade item to be shipped, and is distributed as an attachment to the item. That is, the information code CD may be a printed matter that is displayed in a printed state on a print medium.

The code reader 13 reads the information code CD to obtain the public information recorded in the item code. When the code reader 13 reads the information code CD without using the optical filter 23, it reads the item code. The code reader 13 acquires the public information recorded in the item code and transmits the acquired public information to the system server 10.

The system server 10 is a host node that can communicate with the input terminal 11, the label printer 12, and the code reader 13. The system server 10 registers the item information acquired from the input terminal 11 in a database. The system server 10 prepares public information associated with the item information and generates an item code that records this public information. As part of the process of issuing an item code, the system server 10 transmits image data of the generated item code to the label printer 12 that is the sender of the item information. When the issued item code is circulated together with the item and is read by the code reader 13 of another trader TR, the system server 10 stores a record of the item transaction by this trader TR.

The traceability system 120 is used in combination with the distribution management system 110, and accumulates the transaction record in the same manner as the distribution management system 110. Specifically, the distribution management system 110 corresponds to an old management system, and the traceability system 120 corresponds to a new management system. The traceability system 120 is operated together with the existing distribution management system 110 without substantially changing the distribution management system 110. In addition to a record generation function of accumulating the transaction record, the traceability system 120 has a record reference function of providing the accumulated transaction record in a manner that allows reference thereto. In the traceability system 120, blockchain technology is used to manage the transaction record for the purpose of preventing tampering with the transaction record.

The traceability system 120 collects transaction records using the information code CD based on an item code issued by the system server 10. The traceability system 120 is composed of a code output device 22, a history management server 20, and the like. Furthermore, the traceability system 120 utilizes the input terminal 11, the label printer 12, the code reader 13, etc. of the distribution management system 110. The code output device 22, the code reader 13, and the input terminal 11 are connected via a network to the history management server 20 stored in a data center or the like.

The code output device 22 is installed at the facility of the trader TR where the label printer 12 is installed. The code output device 22 is installed in a manner that interrupts the communication line between the system server 10 and the label printer 12, and acquires the item code data sent from the system server 10 to the label printer 12. The code output device 22 transmits the acquired item code data to the history management server 20.

The code output device 22 receives data of the information code CD generated based on the transmitted item code from the history management server 20. The information code CD further records tracking information as hidden information used in the traceability system 120. The code output device 22 transmits the data of the information code CD to the label printer 12 instead of the data of the item code. Due to such intervention of the code output device 22, the label printer 12 prints the information code CD on a paper medium without recognizing any modification (substitution) of the acquired code data. As a result, instead of the item code, a code print medium on which the information code CD is printed is attached to the item and distributed together with the item.

The history management server 20 is a host node that can communicate with the input terminal 11 in addition to the code output device 22 and the code reader 13. The history management server 20 is mainly configured as a computer including a processor 31, a RAM 32, a storage unit 33, an input/output interface, and a bus connecting these components. The processor 31 is hardware for arithmetic processing, coupled to the RAM 32. The processor 31 includes, for example, at least one type of a central processing unit (CPU), a graphics processing unit (GPU), and a reduced instruction set computer (RISC)-CPU as a core. The processor 31 is configured to access the RAM 32 to perform processes related to data management. The storage unit 33 stores an information code generating program as one of management programs related to data management, for causing the processor 31 to execute the code generating method according to the present disclosure.

In the traceability system 120, one information code CD may be continuously used across multiple traders TR, or a new information code CD may be issued for each trader TR. In the configuration in which the new information code CD is generated for each trader TR, a latest hash value reflecting the transaction record may be generated in response to occurrence of the transaction record in each trader TR. The history management server 20 generates a new information code CD in which the latest hash value is recorded as tracking information, and provides the data of the new information code CD to the label printer 12 at the facility of the trader TR who conducted the transaction. As a result, it continues to be updated to reflect previous transaction records. Furthermore, since the tracking information mainly contains hash values, the amount of data in the tracking information can be maintained constant even as trading of items progresses in the supply chain SC.

When the code reader 13 reads the information code CD through the optical filter 23, it reads out a tracking code, which is an example of the hidden code CH. The code reader 13 acquires the tracking information recorded in the tracking code and transmits the acquired tracking information to the history management server 20.

Whether or not the code reader 13 uses the optical filter 23 may be determined based on the state of a switch operated by the trader TR. Whether or not the code reader 13 uses the optical filter 23 may be determined based on a luminance threshold LT that is set in the binarization process, for example. For example, if the luminance threshold LT is higher than a preset threshold, the code reader 13 may infer that the optical filter 23 is not being used, and information may be transmitted to the system server 10. If the luminance threshold LT is lower than a preset threshold, the code reader 13 may infer that the optical filter 23 is being used, and information may be transmitted to the history management server 20.

In the case where the optical filter unit 3 is attached to the code reader 13, the exposed state and the filter state of the optical filter unit 3 described in the first embodiment may be detected mechanically or electrically to determine whether the optical filter 23 has been used.

Consumers of the final product can view the transaction records of the final product by using a traceability confirmation app installed on a user terminal 50 such as a smartphone or tablet terminal. Specifically, the user terminal 50 reads the code attached to the final product (which may be an information code CD or another additional code issued), and then sends a request to reference the transaction record along with the hash value to the history management server 20, which is the contact point for inquiries. When the history management server 20 receives the reference request, it extracts the item information and transaction record associated with the hash value and generates data to be provided. The history management server 20 transmits the generated reference data to the user terminal 50 that issues the reference request. The consumer of the final product can check a history of the transaction record by loading the reference data transmitted from the history management server 20 using the traceability check application.

According to the second embodiment, the information code CD is a printed matter that is displayed in a printed state on a print medium. The printed information code CD can be issued and distributed at low cost.

Furthermore, according to the second embodiment, the information code CD is configured to be attached to a trading item traded between traders and to be distributed together with the trading item. This allows for proper management of trade items.

### Other Embodiments

While multiple embodiments are described above, the present disclosure is not interpreted as being limited to the embodiments and can be applied to various embodiments and combinations without departing from a spirit of the present disclosure.

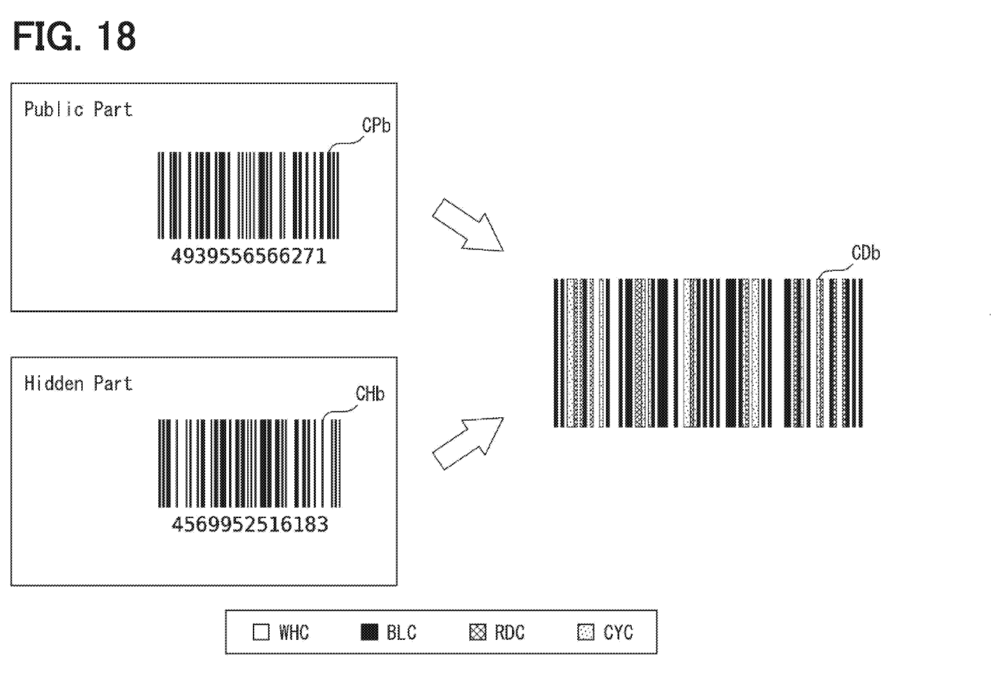

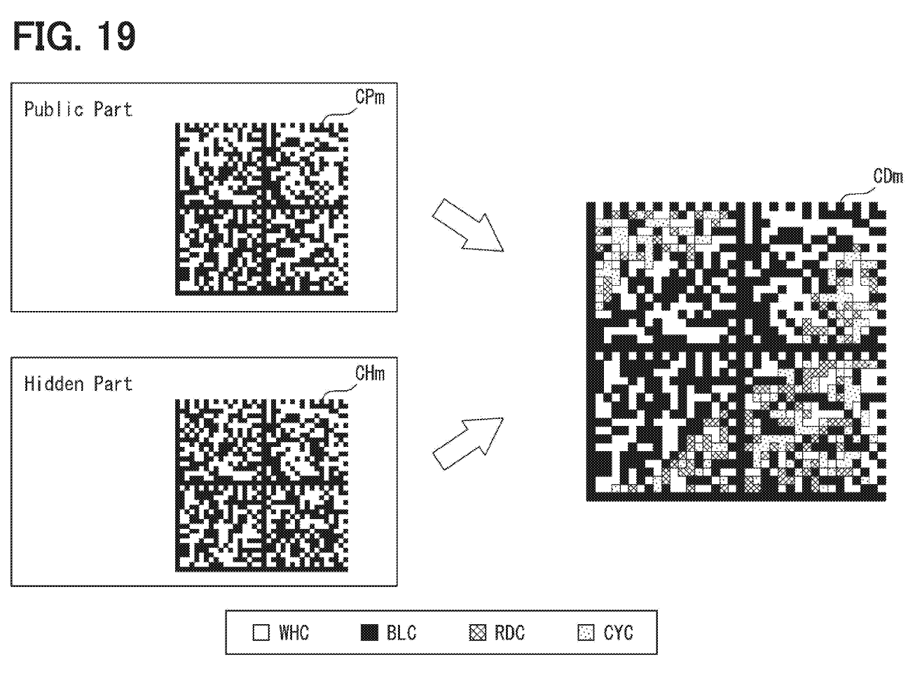

In another embodiment, the information code may be a code other than a QR code. For example, as shown in FIG. 18, an information code CDb may be generated by a process of combining two barcodes CPb and CHb based on the synthesis rule of FIG. 4. The information code CDb stores the two barcodes CPb and CHb superimposed in a common two-dimensional area. For example, as shown in FIG. 19, an information code CDm may be generated by a process of combining two data matrices CPm and CHm based on the synthesis rule of FIG. 4. The information code CDm stores the two data matrices CPm and CHm superimposed in a common two-dimensional area. Furthermore, the information code may store plural different types of codes in superimposed manner on a common two-dimensional area.

In another embodiment, the information code CD may be a printed matter displayed in a printed state on a print medium when used in a retail store or restaurant as described in the first embodiment. In the application used in the traceability system 120 described in the second embodiment, the information code CD may be an image display object displayed on an electronic display device.

In another embodiment, additional color combinations other than red and cyan may be employed. For example, a combination of green and magenta, a combination of blue and yellow, etc. may be employed.

In another embodiment, the black cell BLC may be displayed using a first color similar to black that can be determined as black by binarization process, for example, dark gray. The white cell WHC may be displayed using a second color similar to white that can be determined as white by binarization process, for example, light gray. When the code generating device 1 is set to display the cell as substantially black, the color of the cell displayed on the electronic display device may be within the range of the first color. When the code generating device 1 is set to display the cells as substantially white, the color of the cells displayed on the electronic display device may be within the range of the second color.

In another embodiment, the functions provided by the code generating device 1, the history management server 20, the code reader 2, 13, etc. can be provided by software and hardware that executes it, software only, hardware only, or a combination of these. In cases where the functions are provided by electronic circuits as hardware, the respective functions can be also provided by analog circuits or digital circuits which include a large number of logic circuits.

For example, when the code reader 13 reads hidden information from the information code CD, it may capture a color image without using an optical film, and then perform image processing on the color image by inversely calculating the synthesis rule of FIG. 4 to restore the hidden code CH before synthesis.

The controller and its methods described in the present disclosure may be implemented by a dedicated computer comprising one or more processors programmed to execute functions embodied as a computer program. Alternatively, the device and method described in the present disclosure may be implemented by dedicated hardware logic circuits. Alternatively, the device and method described in the present disclosure may be implemented by one or more dedicated computers configured by a combination of a processor executing a computer program and one or more hardware logic circuits. Further, the computer program may be stored as instructions to be executed by a computer on a non-transitory computer-readable tangible storage medium.

This specification discloses plural technical ideas described as following.

An information code is configured as readable by a reader by performing a binarization process on luminance.

The information code stores a public code representing public information by arranging a plurality of cells in which either a first symbol or a second symbol that can be distinguished by the binarization process is embedded, and a hidden code representing hidden information by arranging a plurality of cells in which either the first symbol or the second symbol is embedded, in superimposed manner in a common two-dimensional area.

A cell in which the first symbol is embedded in the public code and in which the first symbol is embedded in the hidden code is displayed in block.

A cell in which the second symbol is embedded in the public code and in which the second symbol is embedded in the hidden code is displayed in white.

A cell in which the first symbol is embedded in the public code and the second symbol is embedded in the hidden code is displayed in a first auxiliary color.

A cell in which the second symbol is embedded in the disclosure code and the first symbol is embedded in the hidden code is displayed in a second auxiliary color so as to be recognized by the reader under white light with a higher luminance than display in the first auxiliary color, and recognized by the reader under light of the first auxiliary color with a lower luminance than display in the first auxiliary color.

What is claimed is:

1. A display medium including information code to be decoded in response to luminance recognized by a reader, the information code comprising:
a first code indicating first information; and
a second code indicating second information, wherein
the first code and the second code are superimposed and recorded in a common two-dimensional area by arranging cells in which at least one of a first symbol or a second symbol is encoded in each of the first code and the second code,
a cell in which the first symbol is encoded in the first code and the first symbol is encoded in the second code is displayed in a first color, which is rendered as black by a binarization process,
a cell in which the second symbol is encoded in the first code and the second symbol is encoded in the second code is displayed in a second color, which is rendered as white by the binarization process,
a cell in which the first symbol is encoded in the first code and the second symbol is encoded in the second code is displayed in a first auxiliary color, and
a cell in which the second symbol is encoded in the first code and the first symbol is encoded in the second code is displayed in a second auxiliary color, so as to be recognized by the reader as having higher luminance than a display in the first auxiliary color under white light, and recognized by the reader, under light of the first auxiliary color, as having lower luminance than a display in the first auxiliary color.

2. The display medium including information code according to claim 1, wherein
the first auxiliary color is one of three primary colors of light, and
the second auxiliary color is a color obtained by additively mixing the remaining two primary colors of the three primary colors of light.

3. The display medium including information code according to claim 2, wherein
the first auxiliary color is red, and the second auxiliary color is cyan.

4. The display medium including information code according to claim 1, wherein the information code is an image displayed on, as the display medium, an electronic display device.

5. The display medium including information code according to claim 1, wherein the information code is a printed matter displayed in a printed state on, as the display medium, a print medium.

6. The display medium including information code according to claim 1, wherein the information code is to be attached to a trading item traded between traders and to be distributed together with the trading item.

7. An information code generating device comprising: at least one processor with a memory storing computer program to generate an information code that is readable by a reader performing a binarization process on luminance, wherein
the at least one processor is configured to
generate the information code by superimposing and recording a public code and a hidden code in a common two-dimensional area by arranging a plurality of cells in which either a first symbol or a second symbol to be distinguished by the binarization process is embedded, the public code representing public information, the hidden code representing hidden information, and
the at least one processor, in the generating of the information code, is configured to
set a cell in which the first symbol is embedded in the public code and in which the first symbol is embedded in the hidden code to be displayed in black,
set a cell in which the second symbol is embedded in the public code and in which the second symbol is embedded in the hidden code to be displayed in white,
set a cell in which the first symbol is embedded in the public code and the second symbol is embedded in the hidden code to be displayed in a first auxiliary color, and
set a cell in which the second symbol is embedded in the public code and the first symbol is embedded in the hidden code to be displayed in a second auxiliary color so as to be recognized by the reader under white light with a higher luminance than a display in the first auxiliary color and recognized by the reader under light of the first auxiliary color with a lower luminance than a display in the first auxiliary color.

8. A non-transitory storage medium including an information code generating program, to generate an information code to be read by a reader performing a binarization process on luminance, the information code generating program causes at least one processor to
generate the information code by superimposing and recording a public code representing public information and a hidden code representing hidden information in a common two-dimensional area, by arranging a plurality of cells in which either a first symbol or a second symbol that can be distinguished by the binarization process is embedded, wherein
in the generating of the information code, the information code generating program causes the at least one processor to
set a cell in which the first symbol is embedded in the public code and the first symbol is embedded in the hidden code to be displayed in black,
set a cell in which the second symbol is embedded in the public code and the second symbol is embedded in the hidden code to be displayed in white,
set a cell in which the first symbol is embedded by the public code and the second symbol is embedded by the hidden code to be displayed in a first auxiliary color, and
set a cell in which the second symbol is embedded in the public code and the first symbol is embedded in the hidden code to be displayed in a second auxiliary color so as to be recognized by the reader under white light with a higher luminance than a display in the first auxiliary color and recognized by the reader under light of the first auxiliary color with a lower luminance than a display in the first auxiliary color.
